(19) United States
(12) Patent Application Publication
(10) Pub. No.: US 2008/0109401 A1
(43) Pub. Date: May 8, 2008

(54) PRESENTING PREDETERMINED SEARCH RESULTS WITH QUERY SUGGESTIONS

(75) Inventors: Gaurav Sareen, Bellevue, WA (US); Girish Kumar, Redmond, WA (US); Yinzhe Yu, Renton, WA (US); Junhua Wang, Sammamish, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/531,119

(22) Filed: Sep. 12, 2006

(51) Int. Cl. G06F 7/06

(52) U.S. Cl. 707/3; 707/E17.014

(57) ABSTRACT

A system, method, computer-readable media, and related techniques are disclosed for presenting one or more search queries and at least one search result corresponding to at least one of the queries. In an embodiment, the method may include receiving a portion of a search query. In response to receiving at least a portion of the search query, the method may be configured to present to a user one or more suggested search queries and at least one predetermined search result corresponding to at least one of the one or more suggested queries. The method may further include presenting at least one advertisement corresponding to at least one or more suggested search queries.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Search engines have become useful tools in helping users find information of interest across the Internet. Typically, when a user wishes to use a search engine, the user may input a search query into a search box. The user can then submit the search query, which can lead the user to a search results page of one or more search results corresponding to the query. The user may then be able to select one of the search results, in which the selection of the result may lead the user to a web page that he/she can browse.

Some users, however, may not be interested in viewing all of the search results displayed on a search results page and may rather wish to view the most popular search results. For those users, waiting to be directed to a search results page may be an inefficient use of their time. Additionally, some less-savvy users may get confused when viewing a search results page as they may not know which result will best suit their needs.

### SUMMARY

A system, method, computer-readable media, and user interface are disclosed for presenting users with search queries and search results in response to receiving portions of search queries from users. In an embodiment, the system may include a suggestion repository configured to store suggested search queries. The system may further include a cache configured to store predetermined search results that correspond to the suggested search queries stored in the suggestion repository. Moreover, the system may include a query suggestion module configured to identify a suggested search query from the suggested search queries stored in the suggestion repository. The query suggestion module may further be configured to display the identified suggested search query to the user along with at least one predetermined search result.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an exemplary operating environment for implementing the invention.

FIG. 2 is a block diagram of an exemplary system for implementing the invention.

FIG. 3 is a flow diagram of an exemplary method for presenting one or more search queries and a search result corresponding to at least one of the queries.

FIG. 4 is an embodiment of an user interface for displaying suggested search queries with corresponding predetermined search results.

FIG. 5 is a block diagram of an exemplary data structure containing suggested search queries and corresponding predetermined search results.

### DETAILED DESCRIPTION

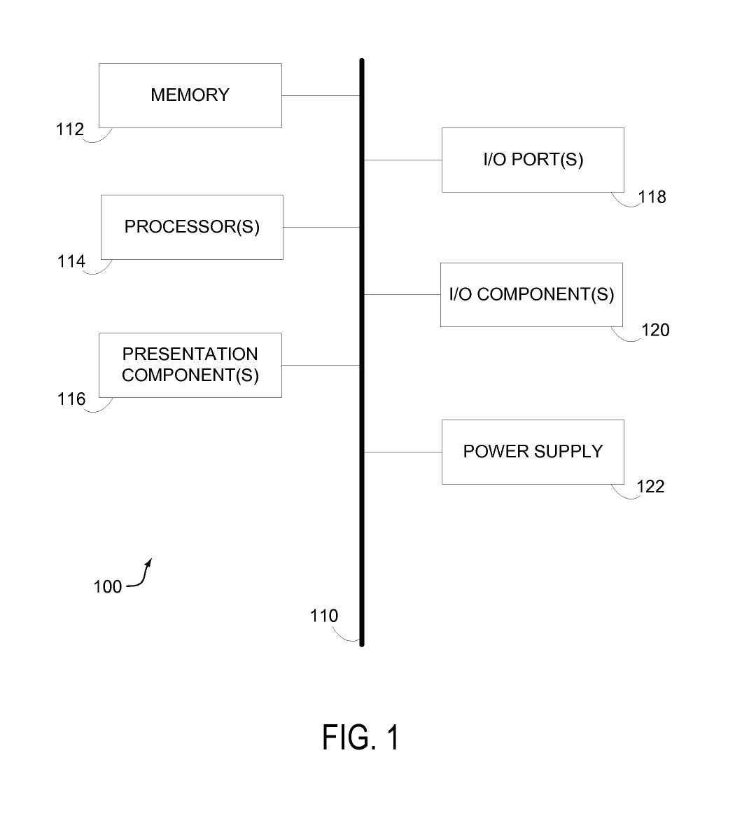

Referring initially to FIG. 1 in particular, an exemplary operating environment for implementing the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It is recognized that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors 114 that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

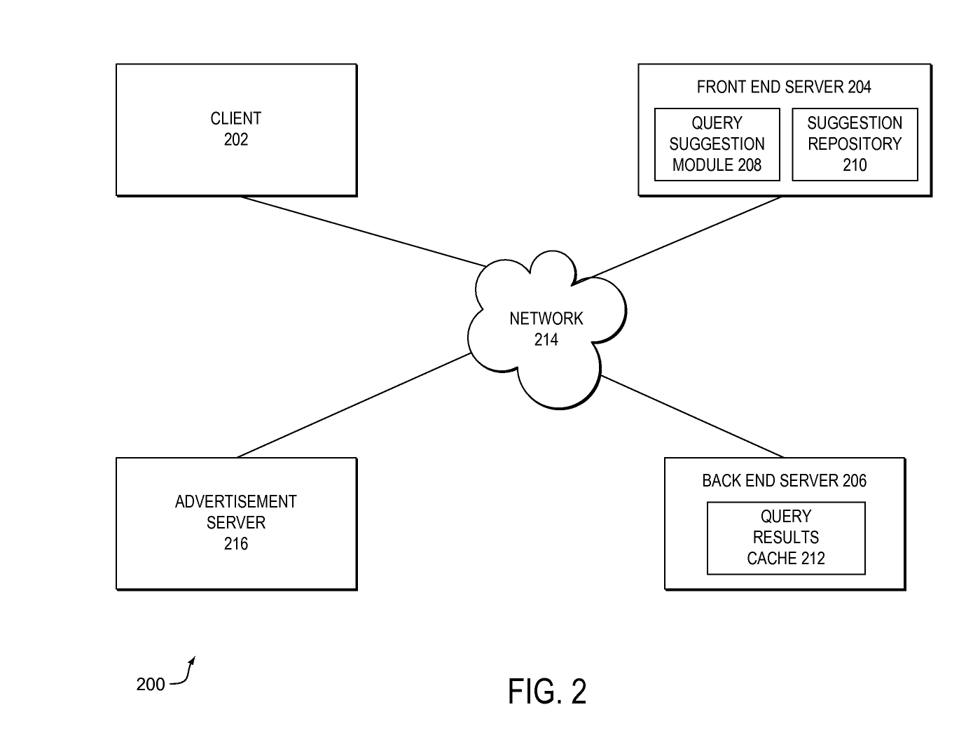

FIG. 2 is a block diagram of an exemplary system 200 for implementing the invention. The system may include devices such as a client 202, a front end server 204, a backend server 206, and an advertisement server 216. Each device may be a computing device as described in FIG. 1. Each device may also include a communication interface. The communication interface may be an interface that can allow a device to be directly connected to any other device or may allow a device to be connected to another device over network 214. Network 214 can include, for example, a local area network (LAN), a wide area network (WAN), or the Internet. In an embodiment, network 214 may be a wireless network.

Client 202 may be or can include a desktop or laptop computer, a network-enabled cellular telephone (with or without media capturing/playback capabilities), wireless email client, or other client, machine or device to perform various tasks including Web browsing, search, electronic mail (email) and other tasks, applications and functions. Client 202 may additionally be any portable media device such as digital still camera devices, digital video cameras (with or without still image capture functionality), media players such as personal music players and personal video players, and any other portable media device.

Client 202 may also be or can include a server such as a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform.

Front end server 204, back end server 206, and advertisement server 216 may be or can include a server such as a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In an embodiment, two or more of the servers may be integrated together into one server. In an embodiment, two or more of the servers may be directly or indirectly connected to each other without using network 214. In an embodiment, one or more of the servers may be search engines or portions of search engines.

Front end server 204 may be configured to receive portions of search queries submitted by a user at a client. With the present invention, the term “portion” is defined to include a 100 percent, completed search query, as well as any percentage of a completed search query under 100 percent (an incomplete search query). For example, if the search query that a user intends to submit is “System,” the full completed query of “System” could represent a 100 percent portion of the intended query. In the same example, the incomplete query of “Sys” of the intended query “System” could represent a 50 percent portion of the intended query. In an embodiment, a portion of a search query may also include errors such as misspellings of intended search queries.

Front end server 204 may additionally include query suggestion module 208 and suggestion repository 210. The front end server can use the query suggestion module 208 and suggestion repository 210 in order to execute a query autocomplete task. In an embodiment, query autocomplete is a feature that can suggest, on-the-fly, a list of most likely search queries that complete the currently typed-in portion of a search query as the user types in the portion of the query. For example, if a user types in “co” in a search box, a list containing “computers,” “coffee,” and “condos” may be suggested.

Query suggestion module 208 may be configured to receive at least a portion of submitted queries and compare the portions to suggestion repository 210 in order to determine the search query that the user intends to submit, or in other words, to determine a suggested search query that completes the currently typed-in portion of the search query. Suggestion repository 210 may be configured to store one or more suggested search queries. In an embodiment, the suggestion repository may be a query log, wherein the query log may be configured to track all search queries submitted by users. Once the query suggestion module 208 compares at least a portion of submitted query, the query suggestion module 208 can be configured to identify the most relevant suggested search queries related to the portion. In an embodiment, the submitted portion may produce suggested search queries that begin with the same characters as the portion. For example, if a user types in “co” in a search box, a list containing “computers,” “coffee,” and “condos” may be suggested. In another embodiment, the portion submitted portion may produce a list of suggested search queries that begin with different characters as the submitted portion. For example if a user types in “windows” in a search box, a list containing “Microsoft Windows” and “Anderson Windows” may be suggested.

In an embodiment, the suggestion repository 210 can store the suggested search queries in a ranked order. The ranked order can be used to determine the most relevant suggested search queries that are related to at least a portion of submitted query. The invention can employ any type of algorithm for determining the ranked order. The ranked order can be based on, for example, popularity. In an embodiment, popularity can be determined by the frequency in which users submit a completed search query, wherein the greater the frequency, the more popular the search query is judged to be. For example, for the submitted portion of a search query such as “com,” if the term “computer” is more popular (has a greater frequency of usage) than the term “comedy,” then “computer” will be ranked higher than “comedy.” In another embodiment, the suggested search queries may be ranked alphabetically. In yet another embodiment, the ranked order may be based on paid advertisements related to the suggested search queries. For example, suggested search queries with associated advertisements may be ranked in an ascending or descending order based on the number of advertisements associated with each suggested search query or based on the amount each advertiser paid to have its advertisement associated with the particular suggested search query. In such an embodiment, suggested search queries that have associated advertisements may be ranked higher than suggested search queries that do not have associated advertisements. In an embodiment, the query suggestion module 208 can be configured to identify any number of suggested search queries as determined by the ranked order. For example, the query suggestion module can identify the top ten suggested search queries and return those to the user for selection of the desired term or terms.

Back end server 206 may be configured to receive the number of suggested search queries as determined by the front end server 204. Back end server 206 may also include query results cache 212. The query results cache 212 may index and store a plurality of predetermined search results. In an embodiment, the search results stored in query results cache 212 are considered “predetermined” because the search results are pre-fetched using the suggested search queries stored in the suggestion repository 210. In an embodiment, pre-fetching the predetermined search results may include taking the suggested search queries stored in suggestion repository 210 and running them through a search engine in order to determine the relevant search results. Once the relevant search results have been determined, they can be considered to be predetermined search results and may be associated with their corresponding suggested search query. The associated predetermined search results and suggested search query may be stored together in the query results cache 212. In another embodiment, the back end server 206 does not use the query results cache. As such, the search results are not predetermined. In such an embodiment, the back end server 206 can determine search results on-the-fly as it receives a number of suggested search results related to a portion of a search query submitted by a user.

In an embodiment, the predetermined search results may be associated in a ranked order with the corresponding suggested search query. The invention can employ any type of algorithm for determining the ranked order. The ranked order can be based on, for example, popularity of the search result. In an embodiment, popularity can be determined by the frequency with which users access each search result on the Internet. In another embodiment, the ranked order may be based on paid advertisements as described above.

When a number of suggested search queries is received, the back end server 206 can compare the suggested search queries to the query result cache in order to identify and provide one or more predetermined search results for each suggested search query. If there is more than one predetermined search result for a suggested search query, the back end server 206 may be configured to provide any number of predetermined search results. For example, the back end server 206 may be configured to provide five predetermined search results. In an embodiment, the predetermined search results are provided in a ranked order.

Advertisement server 216 may be configured to receive the number of suggested search queries as determined by the front end server 204. Advertisement server 216 can be configured to index and store search queries and associated advertisements corresponding to the search queries in a database. If there are multiple advertisements associated with a particular search query, the advertisements can be stored in a ranked order. The invention can employ any type of algorithm for determining the ranked order. The ranked order can be based on, for example, popularity of the advertisement. In an embodiment, popularity can be determined by the frequency with which users access each advertisement on the Internet. In another embodiment, the ranked order may be based on the amount each advertiser paid to have its advertisement associated with the particular search query. In such an embodiment, advertisements that cost more to be associated with a particular search query may be ranked higher than other advertisements.

When a number of suggested search queries is received, the advertisement server 216 can compare the suggested search queries to its database in order to identify and provide one or more advertisement results for each suggested search query. If there is more than one advertisement result for a particular suggested search query, the advertisement server may be configured to provide any number of advertisement results. For example, the advertisement server may be configured to provide five advertisement results. In an embodiment, the advertisement results are provided in a ranked order.

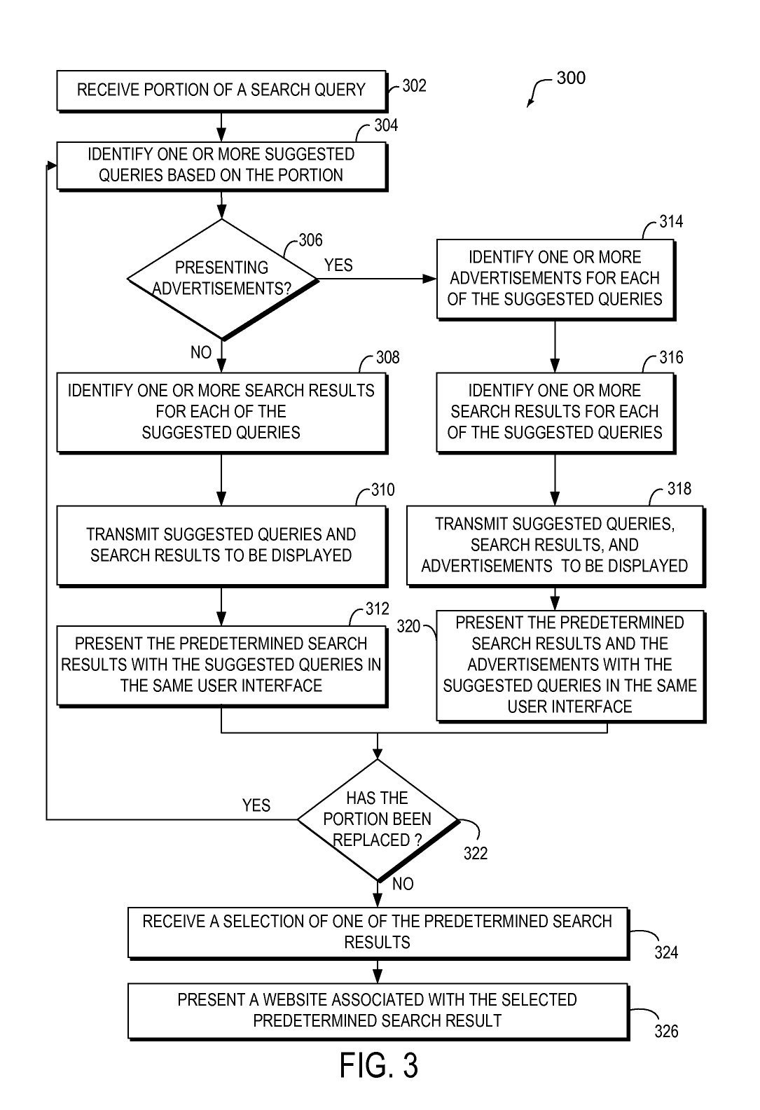

FIG. 3 is a flow diagram of an exemplary method 300 for presenting one or more search queries and at least one search result corresponding to at least one of the queries. At operation 302, a portion of a search query is received. At operation 304, one or more suggested search queries, based on at least a portion of the submitted query, are identified. In an embodiment, the suggested search queries may be determined by a ranking algorithm. The method may be configured to identify any number of suggested search queries.

At operation 306, a determination is made as to whether the system is interested in presenting advertisements. In an embodiment, this determination may be predetermined or set by an administrator. If the system is not interested in presenting advertisements, the method may proceed to operation 308 in which one or more predetermined search results for each of the suggested queries are identified. In an embodiment, the predetermined search results may be determined by a ranking algorithm. The method may be configured to identify any number of predetermined search results for each of the suggested search queries. In an embodiment, operation 306 is not included and the invention is configured to go directly to either operation 308 or 314 from operation 304.

At operation 310, the identified suggested search queries and predetermined search results are transmitted in order to be displayed. At operation 312, the transmitted suggested search queries and the predetermined search results are presented together within the same user interface (UI). In an embodiment, the transmitted suggested search queries and the predetermined search results are presented in the same UI as the submitted query.

If, however, the system is interested in presenting advertisements, at operation 314, one or more advertisements for each of the suggested queries are identified. In an embodiment, the advertisements may be determined by a ranking algorithm. The method may be configured to identify any number of advertisements for each suggested search query. At operation 316, one or more predetermined search results for each of the suggested queries are identified. In an embodiment, the predetermined search results may be determined by a ranking algorithm. The method may be configured to identify any number of predetermined search results for each of the suggested search queries.

At operation 318, the identified suggested search queries, predetermined search results, and advertisements are transmitted in order to be displayed. At operation 320, the transmitted suggested search queries, predetermined search results, and advertisements are presented together within the same UI. In an embodiment, the transmitted suggested search queries, predetermined search results, and advertisements are presented in the same UI as the submitted query.

At operation 322, a determination is made as to whether at least a portion of the search query has been replaced or modified. In an embodiment, replacing or modifying at least a portion of the search query may include adding or deleting a character from the portion. For example, if the intended search query that a user intends to submit is “Microsoft,” the first portion that would be submitted would be the first character of “M” and some combination of operations 302, 304, 306, 308, 310, 312, 314, 316, 318, or 320 may be performed. Once the user adds the next inputted character of “i,” the system would recognize that the previous portion has been replaced and would refresh the suggested search queries and predetermined search results by repeating a method starting at operation 304. This method of refreshing the suggested search queries and predetermined search results may continue until the user has completed inputting his/her search query.

If it is determined that at least a portion of the submitted query has not been replaced or modified, at operation 324 a selection of one of the predetermined search results is received. In an embodiment, the selection can be received by a user selecting a predetermined search result within the UI. The user may use, for example, a mouse, keyboard, touchscreen, joystick, or any other input device to select a predetermined search result within the UI.

In an embodiment, each predetermined search result may include a reference to a website associated with the predetermined search result. Such a reference may be, for example, a URL of the associated website. The predetermined search result may also include a title of the predetermined search result. For example, the suggested search query “computer” may be presented to a user along with the a predetermined search result of “Good Computers, www.website1.com.” In such an example, “Good Computers” could be the title and “www.website1.com” could be the URL reference associated with the predetermined search result. In such an embodiment, the user may select the predetermined search result, and at operation 326, the associated website may be presented.

In another embodiment, a reference to a website associated with the number one ranked predetermined search result may be embedded or included with the suggested search query. For example, the suggested search query “computer” may be presented to a user. A reference to the website of Good Computers, which in this example will be the number one ranked predetermined search result, may be included with the “computer” suggested search query such that the user may be presented with Good Computer's website by simply selecting the “computer” suggested search query.

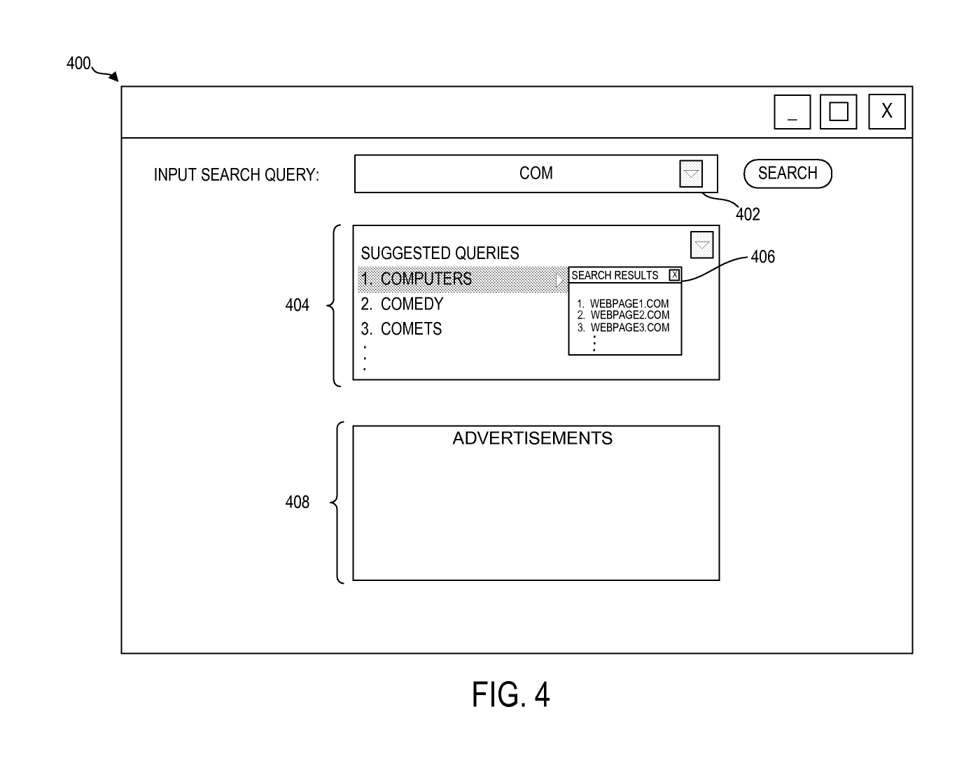

FIG. 4 is an embodiment of a UI 400 for displaying suggested search queries with corresponding predetermined search results. UI 400 can include a first a first screen area 402 that may be configured to display a portion of a search query inputted by a user. UI 400 may additionally include a second screen area 404 that may be configured to display one or more suggested queries based on at least a portion of the submitted query displayed in the first screen area. Moreover, UI 400 may include a third screen area 406 that may be configured to display at least one predetermined search result corresponding to the one or more suggested queries displayed in the second screen area. Furthermore, UI 400 may include a fourth screen area 408 that may be configured to display one or more advertisement results based on at least a portion of the submitted query. In an embodiment, the advertisement results may be displayed together with the predetermined search results within the third screen area 406. In an embodiment, screen areas 402, 404, 406, and 408 may be presented using any type of means such as, but not limited to, side-panes, top-panes, bottom-panes, pop-up windows, or cascading drop-down panes, while being within the same UI.

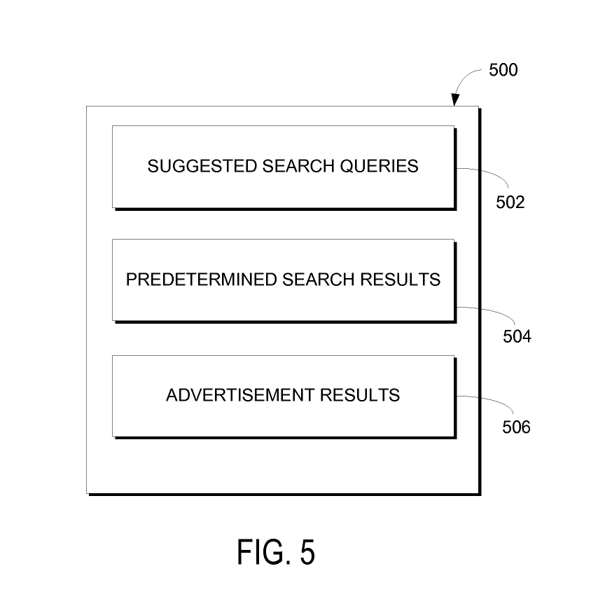

FIG. 5 is a block diagram of an exemplary data structure containing suggested search queries and corresponding predetermined search results. The data structure 500 includes a suggested search query field 502 which may contain one or more suggested search queries related to a portion of a search query. The data structure 500 may also include a predetermined search result field 504 containing one or more predetermined search results associated with the portion of the search query. The data structure 500 may also include an advertisement field 506 containing one or more advertisement results associated with at least a portion of the submitted query. The data structure 500 may be stored on one or more computer-readable media such as a file system.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is well-adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. One or more computer-readable media having computer-usable instructions stored thereon for performing a method for presenting one or more search queries and a search result corresponding to at least one of the queries, the method comprising:
receiving a portion of a search query; and
in response to receiving the portion of the search query, presenting to a user one or more suggested search queries and at least one predetermined search result corresponding to at least one of the one or more suggested queries.

2. The computer-readable media according to claim 1, wherein the one or more suggested search queries are autocomplete search queries.

3. The computer-readable media according to claim 1, wherein the at least one predetermined search result is stored in a cache.

4. The computer-readable media according to claim 1, further comprising receiving a selection of one of the at least one presented predetermined search result.

5. The computer-readable media according to claim 4, wherein the at least one presented predetermined search result includes a reference to a website associated with the at least one presented predetermined search result.

6. The computer-readable media according to claim 5, further comprising presenting the website when the selection has been received.

7. The computer-readable media according to claim 1, wherein at least one of the one or more suggested search queries includes a reference to a website associated with a ranked predetermined search result.

8. The computer-readable media according to claim 1, wherein the one or more suggested search queries and the at least one predetermined search results are refreshed each time the portion is modified.

9. The computer-readable media according to claim 1, further comprising presenting at least one advertisement corresponding to at least one of the one or more suggested search queries.

10. The computer-readable media according to claim 9, wherein the at least one advertisement is presented with the at least one presented predetermined search result.

11. A system for presenting users with search queries and search results in response to receiving portions of search queries from users, the system comprising:
a suggestion repository configured to store suggested search queries;
a cache configured to store predetermined search results corresponding to suggested search queries stored in the suggestion repository; and
a query suggestion module configured to identify at least one suggested search query from the suggested search queries stored in the suggestion repository for display to the user along with at least one predetermined search result corresponding to the identified query.

12. The system according to claim 11, wherein the query suggestion module compares a portion of a search query inputted by a user to the suggested search queries stored in the suggestion repository in order to identify the at least one suggested search query.

13. The system according to claim 12, wherein the query suggestion module retrieves the at least one predetermined search result based on the identified at least one suggested search query.

14. The system according to claim 13, wherein the query suggestion module transmits the at least one predetermined search result for presentation within a user interface.

15. The system according to claim 11, further comprising an advertisement database for storing one or more advertisements associated with one or more search queries.

16. The system according to claim 15, wherein the query suggestion module retrieves the one or more advertisements based on the identified one or more suggested queries.

17. A graphical user interface embodied on one or more computer-readable media and executable on a computer for presenting on a display screen one or more search queries and one or more search results corresponding to at least one of the queries, the graphical user interface comprising:
a first screen area configured to display a portion of a search query inputted by a user;
a second screen area configured to display one or more suggested queries based on the portion of the search query displayed in the first screen area; and
a third screen area configured to display at least one predetermined search result corresponding to the one or more suggested queries displayed in the second screen area.

18. The graphical user interface according to claim 17, further comprising a fourth screen area configured to display one or more advertisements based on at least one of the portion of the search query and the one or more suggested queries.

19. The graphical user interface according to claim 18, wherein the second, third, and fourth screen areas are refreshed each time the portion of the search query is modified.

20. The graphical user interface according to claim 17, wherein the at least one predetermined search result includes a reference to a website associated with the at least one predetermined search result.
